(19) United States
(12) Patent Application Publication
(10) Pub. No.: US 2003/0163492 A1
(43) Pub. Date: Aug. 28, 2003

(54) Automated information disclosure system

(76) Inventor: Russell D. Slifer, Minneapolis, MN (US)

Correspondence Address: Russell D. Slifer, 2478 Warm Springs, Boise, ID, 83712, US

(21) Appl. No.: 10/081,226

(22) Filed: Feb. 22, 2002

(51) Int. Cl. G06F 12/00

(52) U.S. Cl. 707/204

(57) ABSTRACT

A patent application management system maintains a database of references for numerous patent applications. The system copies reference information from an originating application to related patent applications. To reduce the possibility that references are not properly cited to a patent office, the system automatically enters a docket entry to schedule a review of the references and prepare a citation document. The docket is then viewable by a patent practitioner to provide a reminder of the pending task.

### FIELD OF THE INVENTION

The present invention relates generally to legal practice management and in particular the present invention relates to information disclosure in patent law.

### BACKGROUND OF THE INVENTION

Patent preparation is a complex and intricate system of communications between a patent applicant and a patent office. Often the applicant is represented by an agent or attorney. These representatives typically manage multiple patent applications simultaneously and must rely on a docket. Dockets are generally either paper or electronic calendars that indicate tasks that need to be completed for each application. When a task is completed, the docket is updated. Revolving due dates can be implemented for tasks that do not have a specific due date.

A patent applicant has a duty to disclose to the patent office information that is relevant to the patentability of the invention to be protected. This information can be disclosed in the Background section of the application or provided to the patent office in an Information Disclosure Statement. The applicant is under a duty to disclose relevant information, such as patents or references, while the application is pending.

A difficulty arises in keeping track of references that are uncovered in one application and may need to be cited to the patent office in a related application. Some case management systems have been developed that keep track of details, documents and references for patent applications. These systems make patent prosecution more efficient and reduce errors. One prior system maintained a database of references for each patent application. The system also tracked related patent applications. If a reference was cited to a patent office in a first application, the system copied the reference information to data bases of related patent applications. A visual note was then triggered on the database screen of the related patent applications, such as a note simply stating “# unmarked references”. This note indicated that some references (# or references) were entered into the database but not cited to the patent office. This system created the opportunity for errors as a result of the note. That is, the system integrity relied on the agent or attorney to execute the database and open a patent application screen to view the note. Because there are long periods of inactivity during patent application prosecution, there is often no motivation to randomly view each application database. As a result, references were typically not cited to the patent office until a reason was provided to open the application database, such as the receipt of a notice of allowance. This system, therefore, slowed the patent applications system, added additional cost to prosecution and created potential liability and ethical problems. This prior system did not include a docketing module to generate viewable dockets indicating due dates for application tasks. As such, an alternative to this system is to rely on manually docket entries in a separate docket system. As with any manual intensive process, this alternative is prone to errors.

For the reasons stated above, and for other reasons stated below which will become apparent to those skilled in the art upon reading and understanding the present specification, there is a need in the art for a patent database system that increases the efficiency of reference tracking.

### BRIEF DESCRIPTION OF THE DRAWINGS

FIG. 1 is a block diagram of a system according to one embodiment of the present invention; and

FIG. 2 is a flow chart of one method of the present invention.

### DETAILED DESCRIPTION OF THE DRAWINGS

In the following detailed description of the preferred embodiments, reference is made to the accompanying drawings, which form a part hereof, and in which is shown by way of illustration specific preferred embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims.

The present invention provides a system to more efficiently manage patent application prosecution. In one embodiment, a database is maintained of references relating to patent applications. When a new reference is added to an application database for an originating application, the references are also automatically entered into the database of related applications. To reduce the possibility that references are not properly cited to a patent office, the system automatically enters a docket entry to schedule a review of the references and prepare a citation document. The docket is then viewable by a patent practitioner to provide a reminder of the pending task. Thus, an improvement over prior systems that performed similar management functions includes the docketing of an Information Disclosure Statement (IDS) on a viewable docket calendar, explained below.

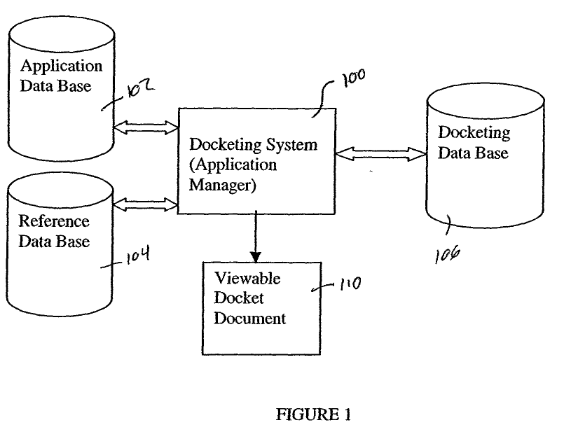

Referring to FIG. 1, an embodiment of the present invention is explained in detail. The system can be executed using a processor. In an office environments, the docketing system 100, or application manager, is a software program(s) executed using a main processor, or server (not shown). The docketing system interacts with an application database 102, a reference database 104, and a docketing database 106. The application database 102 maintains the application specific information, such as inventor name, filing date, serial number, and historical record of transactions for each patent application. The reference database 104 maintains a record of references considered, cited to a patent office and received from a patent office for each application. The docketing database 106 maintains a record of future transactions that are scheduled to be taken for each application. In essence, a “to-do” list for each application. The application manager provides a viewable docket 110 for each agent or attorney. The docket can be either electronic or printed on paper for viewing. One example of a simplified docket entry is illustrated in Table 1.

TABLE 1
Viewable Docket Calendar

| Application | Action Required | Due Date | Attorney |
|---|---|---|---|
| 09/XXX,XXX | Information Disclosure | XX/XX/XX | ABC |
| | Statement | | |
| | based on Reference from | | |
| | Related Application | | |

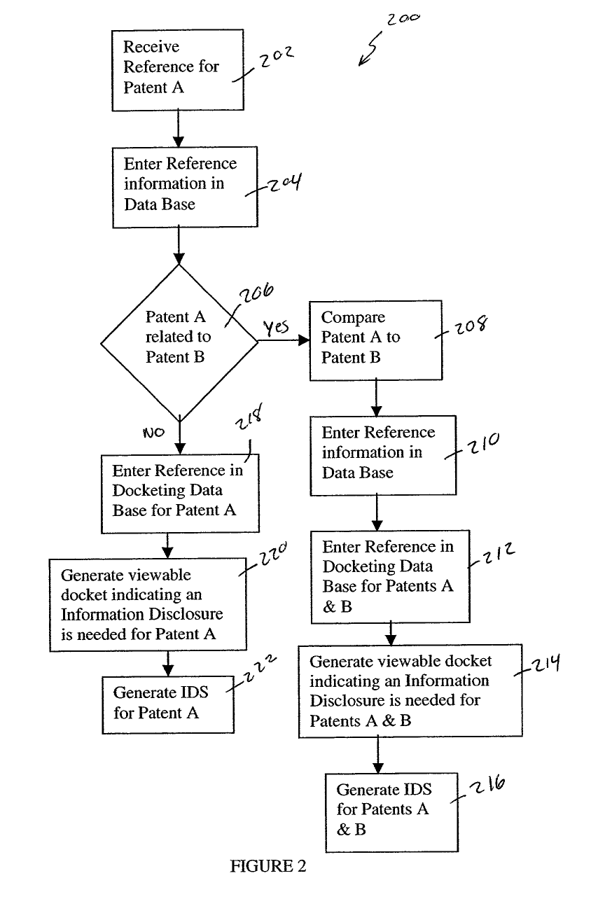

As known to those skilled in the art, a docket is used daily by patent practitioners to insure that necessary actions are being taken for each application. The present invention includes reference citation entries on the docket to keep the practitioner informed when references for related applications are entered in the database. Referring to FIG. 2, a flow chart of one embodiment 200 of the present invention is described. The first operation is the receipt of a reference 202 for a first patent application (Patent A). The reference may be received from the inventor, assignee of the application, a patent office, or other source. The reference information is entered into the reference database 204, such as title, author, publication date and a scanned image of the reference. If Patent A is related 206 to one or more other patents, such as Patent B, the application manager compares the reference list for Patent A to the reference list for Patent B 208. When references entered for Patent A are not present in the database for Patent B, the system copies the reference data to Patent B's database 210. The necessary information is now entered into related patent application databases.

The present system performs an additional function not provided by prior application management systems. This function includes the generation of a docket database entry that schedules the creation of an Information Disclosure Statement (IDS) for the related patent application, Patent B 212. Optionally, a docket entry can be created for Patent A. It is typical, however, to create the IDS for Patent A as soon as the reference is received. As such, a docket entry may not be necessary, but does provide a level of safety. The docket entry can be for any time period, such as a revolving 30-day notice. As such, an entry will appear on the practitioner's docket indicating that an IDS is needed for references received on a related application. The entry will continue to appear monthly until the task is completed and removed from the docket. Optionally, the application manager can print an IDS for either, or both, Patent A and B 216.

If Patent A is not related to Patent B 206, the reference can be entered into the docketing database for Patent A. The system then generates a docket 220 that is viewable by a practitioner for Patent A. Likewise, an IDS can be generated 222 by the system automatically.

### CONCLUSION

A patent application management system has been described that maintains a database of references for numerous patent applications. The system copies reference information from an originating application to related patent applications. To reduce the possibility that references are not properly cited to a patent office, the system automatically enters a docket entry to schedule a review of the references and prepare a citation document. The docket is then viewable by a patent practitioner to provide a reminder of the pending task.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. In a patent application manager system maintaining a database of references, a method comprising:
entering reference data in a database for a first patent application;
copying the reference data to a database for a second patent application, where the second patent application is related to the first patent application;
automatically creating a docket entry in a docketing database using the application manager system, wherein the docket entry indicates that references have been entered for the second patent application and a may need to be cited to a patent office; and
generating a viewable docket including the docket entry.

2. The method of claim 1 further comprises automatically creating an information disclosure statement including the reference data.

3. The method of claim 1 wherein the viewable docket is a hard copy.

4. The method of claim 1 wherein the viewable docket is electronic and viewable on a screen.

5. A patent management system comprising:
a docket database to maintain due dates for patent application tasks;
a reference database to maintain reference data for patent applications; and
an application manager to copy reference data from a first patent application to a second related application, the application manager automatically generates a docket entry in the docket database for the second application.

6. The method of claim 5 further comprises automatically creating an information disclosure statement including the reference data.

7. A machine readable medium comprising:
machine readable code to instruct a processor to copy reference data for a first patent application to a database for a second patent application, where the second patent application is related to the first patent application;
machine readable code to instruct a processor to automatically create a docket entry in a docketing database using the application manager system, wherein the docket entry indicates that references have been entered for the second patent application and a may need to be cited to a patent office.

8. The machine readable medium of claim 7 further comprising machine readable code to instruct a processor to generate a viewable docket including the docket entry.
